(19) United States
(12) Patent Application Publication
(10) Pub. No.: US 2026/0366732 A1
(43) Pub. Date: Nov. 19, 2026

(54) COOKING APPARATUS

(71) Applicant: LG Electronics Inc., Seoul (KR)

(72) Inventors: Hyeunsik NAM, Seoul (KR); Junghyeon CHO, Seoul (KR); Jaepyo HONG, Seoul (KR); Seongjun KIM, Seoul (KR); Jonghyun LEE, Seoul (KR); Eunjung SHIN, Seoul (KR)

(73) Assignee: LG Electronics Inc., Seoul (KR)

(21) Appl. No.: 19/487,508

(22) PCT Filed: Nov. 14, 2024
(86) PCT No.: PCT/KR2024/017923

§ 371 Date: Nov. 25, 2025

(30) Foreign Application Priority Data
Nov. 23, 2023 (KR) 10-2023-0164184

(51) Int. Cl. F24C 15/10; F24C 7/06; F24C 15/22

(52) U.S. Cl. CPC F24C 15/10; F24C 7/067; F24C 15/22

(57) ABSTRACT

The present invention relates to a cooking appliance comprising: an outer heat insulation material disposed outside a heat insulation material in which a heating coil is accommodated; and a reflector disposed in an inner accommodation space of the heat insulation material to reflect radiant heat generated by the heating coil toward a top plate, whereby the heating efficiency and power efficiency of the heating coil can be improved.

### TECHNICAL FIELD

The present disclosure relates to a cooking appliance, and more specifically, to a cooking appliance constructed such that an outer thermal insulator is disposed on an outer surface of a thermal insulator accommodating therein a heating coil, and a reflector for reflecting radiant heat generated from the heating coil toward a top plate is disposed in an inner accommodation space of the thermal insulator, thereby improving heating efficiency and power efficiency of the heating coil

### BACKGROUND ART

A cooking appliance refers to a type of a home appliance for cooking food, and is an apparatus installed in a kitchen space to cook food according to a user's intention.

Such cooking appliances may be classified in various ways based on a type or a form of a used heat source, and a type of a fuel.

Among such cooking appliances, a cooktop in which an object to be cooked is placed thereon and is heated using a heat source disposed under is used.

The cooktops may be classified into a cooktop including a gas type heater using gas combustion, a cooktop including a radiant type heater using heat generation of an electric heater, a cooktop including an induction type heater operating in an induction heating manner, etc. according to the type of the heat source.

In particular, the cooktop including each of the radiant type heater and the induction type heater may have a structure capable of preventing direct exposure to a heat source, and have an excellent outer appearance compared to the cooktop including the gas type heater, and may not generate the combustion gas and thus is preferred by a user.

In this regard, U.S. Pat. No. 11,536,460 (prior document 001) discloses a cooking appliance including the radiant type heater.

The heater of the cooking appliance disclosed in Prior Document 001 includes a heating coil provided as a resistance heating element, and a container-shaped thermal insulator for accommodating the heating coil therein, wherein the heat generated from the heating coil is transferred to a top plate and then transferred to the container so that food stored in the container may be cooked.

### DISCLOSURE

### Technical Problem

The heater of the cooking appliance disclosed in the prior art document 001 is constructed such that only a container-shaped thermal insulator is used to prevent the heat generated from the heating coil from being transferred to the remaining portions except for the top plate.

Accordingly, the heater of the cooking appliance disclosed in the prior art document 001 is constructed such that a considerable amount of the heat generated from the heating coil is transferred to the thermal insulator in a conduction and radiation manner, and is discharged to an inner space of the cooktop through an outer surface of the thermal insulator.

Therefore, the heater of the cooking appliance disclosed in Prior Document 001 has a problem in that the considerable portion of the amount of the heat generated from the heating coil is not transferred to the top plate and the container but is discharged to the inner space of the cooktop through the outer surface of the thermal insulator, thereby acting as power loss, and accordingly, the heating efficiency and power efficiency of the heating coil may be significantly lowered.

The present disclosure has been devised to solve such problems of the prior art. Thus, a first purpose of the present disclosure is to provide a cooking appliance constructed such that an outer thermal insulator is disposed on an outer surface of a thermal insulator accommodating therein the heating coil, thereby improving heating efficiency and power efficiency of a heating coil.

In addition, a second purpose of the present disclosure is to provide a cooking appliance constructed such that a reflector for reflecting radiant heat generated from the heating coil toward a top plate is disposed in an inner accommodation space of the thermal insulator, thereby further improving the heating efficiency and power efficiency of the heating coil.

The purposes of the present disclosure are not limited to the above-mentioned purposes, and other purposes and advantages of the present disclosure that are not mentioned may be understood based on the following descriptions, and will be more clearly understood based on the embodiments of the present disclosure. In addition, it will be readily appreciated that the purposes and advantages of the present disclosure may be realized by means indicated in the claims and combinations thereof.

### Technical Solution

A cooking appliance according to the present disclosure may include: a heating unit; and a top plate disposed on top of the heating unit to shield the heating unit, wherein a container for cooking may be seated on the top plate; wherein the heating unit may include: a heating coil generating heat in an electric resistance manner; a thermal insulator accommodating the heating coil in an inner space defined therein; a casing coupled to an outer surface of the thermal insulator; and a thermal efficiency improvement means disposed in the inner space of the thermal insulator or disposed on an outer surface of the casing so as to improve heating efficiency of the heating coil.

Moreover, the thermal efficiency improvement means may include: a first outer thermal insulator coupled to an outer surface of a bottom surface portion of the casing and covering the bottom surface portion of the casing.

Moreover, the heating unit may include: a first holder for fixing the first outer thermal insulator to the bottom surface portion of the casing.

Moreover, the first holder may have first through-holes formed to pass therethrough toward the bottom surface portion of the casing, wherein the bottom surface portion of the casing may have fastening holes formed to pass therethrough and respectively positioned at positions corresponding to positions of the first through-holes.

Moreover, the first outer thermal insulator may have a lower heat resistance temperature than a heat resistance temperature of the thermal insulator.

Moreover, the thermal efficiency improvement means may include: a second outer thermal insulator coupled to an outer side surface of a cylindrical side surface portion of the casing to cover the cylindrical side surface portion of the casing.

Moreover, the heating unit may include: a second holder for fixing the second outer thermal insulator to the cylindrical side surface portion of the casing.

Moreover, the second holder may include a connection tab bent from the second holder toward a bottom surface portion of the casing, wherein the connection tab may have second through-holes formed to pass therethrough toward the bottom surface portion of the casing, wherein the bottom surface portion of the casing may have fastening holes formed to pass therethrough in an up-down direction and respectively positioned at positions corresponding to positions of the second through-holes.

Moreover, the second outer thermal insulator may have a lower heat resistance temperature than a heat resistance temperature of the thermal insulator.

Moreover, the thermal efficiency improvement means may include: a first outer thermal insulator coupled to an outer surface of a bottom surface portion of the casing and covering the bottom surface portion of the casing; and a second outer thermal insulator coupled to an outer side surface of a cylindrical side surface portion of the casing to cover the cylindrical side surface portion of the casing, wherein the first outer thermal insulator and the second outer thermal insulator may be integrally formed with each other.

Moreover, the thermal efficiency improvement means may include: a reflector disposed in the inner space defined in the thermal insulator, and disposed between an inner circumferential surface of the thermal insulator and the heating coil, wherein the reflector reflects heat generated from the heating coil therefrom such that the reflected heat may be directed toward the top plate.

Moreover, the reflector may have an inner circumferential surface facing toward the heating coil and an outer circumferential surface facing toward the inner circumferential surface of the thermal insulator, wherein the inner circumferential surface of the reflector may have a higher reflectance than a reflectance of the outer circumferential surface of the reflector.

Moreover, the inner circumferential surface of the reflector may be surface-treated to have a higher reflectance than a reflectance of the outer circumferential surface of the reflector.

Moreover, the inner circumferential surface of the reflector may be coated with a material having a higher reflectance than a reflectance of the outer circumferential surface of the reflector.

Moreover, the reflector may have an inner circumferential surface facing toward the heating coil and an outer circumferential surface facing toward the inner circumferential surface of the thermal insulator, wherein the outer circumferential surface of the reflector may be disposed to be in contact with the inner circumferential surface of the thermal insulator.

Moreover, the inner circumferential surface of the reflector may be a vertical surface extending at a right angle and in parallel with the inner circumferential surface of the thermal insulator.

Moreover, the inner circumferential surface of the reflector may be an inclined surface tilted toward the top plate.

Moreover, the inner circumferential surface of the reflector may be a curved surface concave toward the top plate.

Moreover, the reflector may have an inner circumferential surface facing toward the heating coil and an outer circumferential surface facing toward the inner circumferential surface of the thermal insulator, wherein a separation space may be defined between the outer circumferential surface of the reflector and the inner circumferential surface of the thermal insulator.

Moreover, the reflector may have a protrusion formed to protrude from the outer circumferential surface of the reflector toward the inner circumferential surface of the thermal insulator.

### Advantageous Effects

The cooking appliance according to the present disclosure is constructed such that the outer thermal insulator is disposed on the outer surface of the thermal insulator accommodating therein the heating coil, thereby improving the heating efficiency and power efficiency of the heating coil.

In addition, the cooking appliance according to the present disclosure is constructed such that the reflector for reflecting radiant heat generated from the heating coil toward the top plate is disposed in an inner accommodation space of the thermal insulator, thereby further improving the heating efficiency and power efficiency of the heating coil.

In addition, the cooking appliance according to the present disclosure is constructed such that the outer thermal insulator and the reflector are attached and fixed to the thermal insulator while a structural change of the thermal insulator and the casing constituting the heating unit is minimized, thereby minimizing a design change and minimizing an increase in a manufacturing cost.

In addition to the above-described effects, specific effects of the present disclosure will be described together while describing specific matters for implementing the present disclosure.

### DESCRIPTION OF DRAWINGS

FIG. 1 is a front perspective view of a cooking appliance according to an embodiment of the present disclosure.

FIG. 2 is an exploded perspective view of the cooktop illustrated in FIG. 1.

FIGS. 3 and 4 are a perspective view and a bottom view of the heating unit constituting the cooktop shown in FIG. 2.

FIG. 5 is an exploded perspective view of the heating unit shown in FIG. 3.

FIG. 6 is a bottom perspective view illustrating a state in which a first outer thermal insulator is attached to a bottom surface of a casing of the heating unit according to a first embodiment of the present disclosure.

FIG. 7 is an exploded perspective view of FIG. 6.

FIGS. 8 and 9 are respectively a top perspective view and a bottom perspective view illustrating a state in which a second outer thermal insulator is attached to an outer circumferential surface of a casing of a heating unit according to a second embodiment of the present disclosure.

FIG. 10 is an exploded perspective view of FIG. 9.

FIG. 11 is an exploded perspective view illustrating a configuration in which a first outer thermal insulator and a second outer thermal insulator are integrated with each other and attached to a casing of a heating unit according to a third embodiment of the present disclosure.

FIG. 12 is a top perspective view illustrating a configuration in which a reflector is disposed in an inner space defined by a thermal insulator of a heating unit according to a fourth embodiment of the present disclosure.

FIG. 13 is an exploded perspective view of FIG. 12.

FIG. 14 is a partially enlarged view of the reflector as shown in FIG. 13.

FIG. 15 is an exploded perspective view for illustrating a configuration in which a lower end fixing portion is added to the reflector shown in FIG. 13.

FIGS. 16 to 19 are cross-sectional views in an up-down direction of the heating unit illustrated in FIG. 12 and are cross-sectional views illustrating configurations in which reflectors having different cross-sectional shapes are provided.

### BEST MODE

The above-mentioned purposes, features, and advantages will be described in detail later with reference to the attached drawings, so that those skilled in the art in the technical field to which the present disclosure belongs may easily practice the technical ideas of the present disclosure. In describing the present disclosure, upon determination that a detailed description of the publicly known technology related to the present disclosure may unnecessarily obscure the gist of the present disclosure, the detailed description thereof will be omitted. Hereinafter, a preferred embodiment according to the present disclosure will be described in detail with reference to the attached drawings. In the drawings, identical reference numerals are used to indicate identical or similar components.

Although first, second, etc. are used to describe various components, these components are not limited by these terms. These terms are merely used to distinguish one component from another component. Thus, unless specifically stated to the contrary, the first component may be the second component.

As used herein, unless otherwise stated, each component may be provided as one or more components.

Hereinafter, a first component being disposed “on top of (or under)” a second component may mean that the first component may be disposed in contact with a top surface (or a bottom surface) of the second component, as well as a third component may be interposed between the second component and the first component disposed “on top of (or under)” the second component.

Furthermore, when a first component is described as being “connected” or “coupled” to a second component, the components may be directly connected or coupled to each other, but a third component may be “interposed” between the components or the components may be “connected” or “coupled” to each other via the third components.

As used herein, the singular constitutes “a” and “an” are intended to include the plural constitutes as well, unless the context clearly indicates otherwise. In this application, terms such as “composed of” or “include” should not be construed as necessarily including all of various components or operations described herein, but should be construed that some components or operations among those may not be included or additional components or operations may be further included.

As used herein, the singular constitutes “a” and “an” are intended to include the plural constitutes as well, unless the context clearly indicates otherwise. In this application, terms such as “composed of” or “include” should not be construed as necessarily including all of various components or operations described herein, but should be construed that some components or operations among those may not be included or additional components or operations may be further included.

Throughout the present document, “A and/or B” means A, B, or A and B, unless otherwise specified, and “C to D” means equal to or greater than C and equal to or smaller than D unless otherwise specified.

Hereinafter, the present disclosure will be described with reference to drawings showing a configuration according to an embodiment of the present disclosure.

### Overall Structure of Cooking Appliance

Hereinafter, an overall structure of a cooking appliance 1 according to an embodiment of the present disclosure will be described in detail with reference to the accompanying drawings.

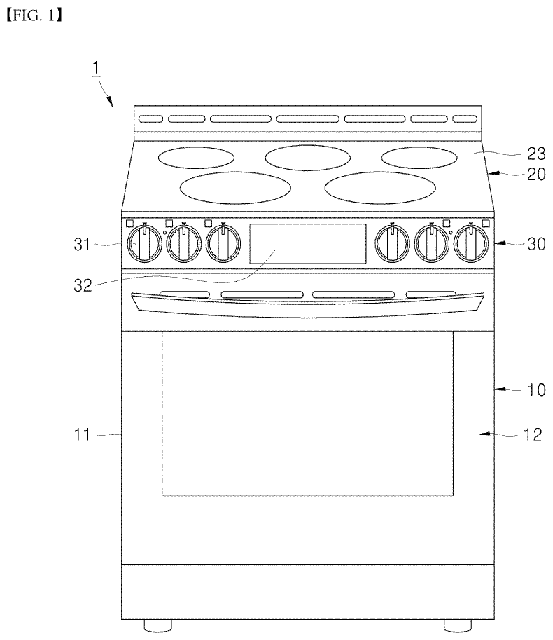

FIG. 1 is a front view of the cooking appliance 1 according to an embodiment of the present disclosure.

Referring to FIG. 1, the cooking appliance 1 according to an embodiment of the present disclosure may include a cooktop 20 and an oven 10.

As illustrated, the cooktop 20 may be disposed on top of the oven 10, and the oven 10 may constitute a lower portion of the cooking appliance 1.

Each of the cooktop 20 and the oven 10 may be provided to constitute the cooking appliance 1 alone, and may be mounted in a built-in manner in a furniture cabinet such as a sink or may be disposed in a freestanding type.

In one example, the present disclosure will be described below in detail with reference to a structure of a multi-functional cooking appliance in which the cooktop 20 is disposed on top of the oven 10 and the cooktop and the oven are integrated with each other. However, the present disclosure is not limited thereto.

The oven 10 may include a main body 11 having a cavity having an open front surface, and a door 12 pivotably connected to the main body 11 to open and close the cavity.

The cavity has a cooking space defined therein, and various types of heating sources such as a heater or a burner are disposed therein to heat the cooking space to cook food.

In the cooktop 20 disposed on top of the oven 10, a container (not shown) containing food to be cooked may be seated on a top plate 23, and a heating unit 22 disposed under the top plate 23 may indirectly heat the container through the top plate 23.

In addition, the cooking appliance 1 may further include a manipulator 30.

As illustrated, the manipulator 30 may include a plurality of knobs 31, and may control operations of the oven 10 and the cooktop 20.

In addition, if necessary, the manipulator 30 may be embodied as a button, a switch, or a touch manipulation device.

As illustrated, the manipulator 30 may be disposed on a front surface of the cooktop 20 or may be disposed on a front surface of the oven 10.

In addition, a display 32 for visually displaying an operating state of the cooking appliance 1 may be provided in proximity to the manipulator 30.

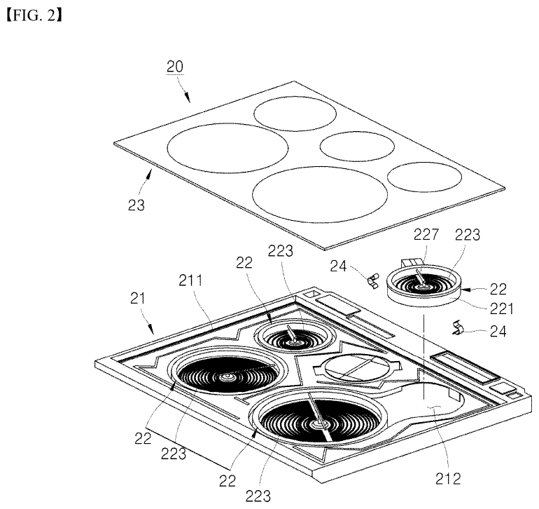

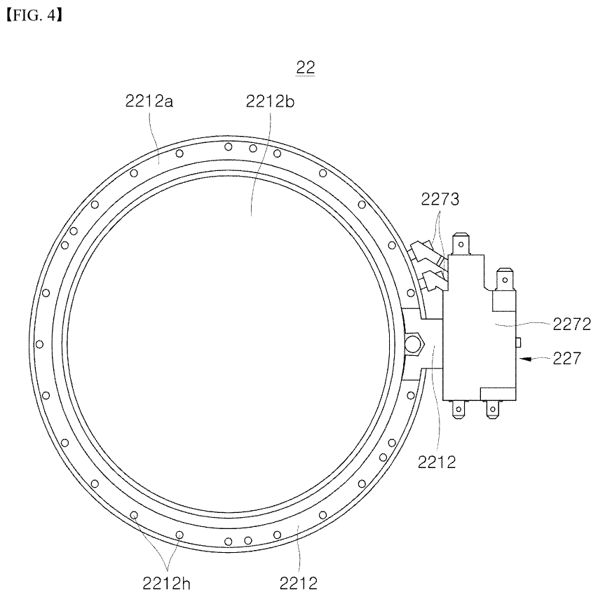

Hereinafter, a detailed structure of the cooktop 20 will be described in detail with reference to FIGS. 2 to 5.

FIG. 2 is an exploded perspective view illustrating the cooktop 20 according to an embodiment of the present disclosure.

As illustrated, the cooktop 20 may include the top plate 23 on which the container is seated, the heating unit 22 disposed under the top plate 23, and a base plate 21 supporting the heating unit 22 and the top plate 23.

The base plate 21 may be formed to have a general rectangular outer appearance, and may define an overall structure of the cooktop 20 and function as a frame capable of supporting the heating unit 22 and the top plate 23.

As illustrated, the base plate 21 may provide a structure in which the heating unit 22 and the top plate 23 may be mounted.

To this end, the base plate 21 may be formed by processing a metal plate so as to have a predetermined rigidity and minimize the influence of heat generated from the heating unit 22.

In a type in which the cooktop 20 is independently installed, the base plate 21 may constitute the outer appearance of the remaining portions except for the upper surface of the cooktop 20. In this case, the base plate 21 may constitute the outer appearance of the cooktop 20, and thus may also be referred to as a casing.

A heating unit receiving hole 212 receiving the heating unit 22 therein may be formed to extend through the base plate 21 in the up-down direction. The heating unit 22 may be disposed in such a manner that the heating unit passes through the heating unit receiving hole 212 and is partially inserted into the heating unit receiving hole 212.

In this regard, the heating unit 22 may be connected to the heating unit receiving hole 212 via a plurality of springs 24 so that an amount of heat generated from the heating unit 22 and transferred to the base plate 21 may be minimized, and the heating unit 22 may be elastically supported. Although FIG. 2 illustrates a configuration in which the heating unit 22 is elastically supported using a pair of springs 24, this is only an example, and the number of springs 24 may be adjusted to vary according to the size or weight of the heating unit 22.

As will be described later, a plurality of fastening holes 2212h may be formed in the bottom surface portion 2212 of the casing 221 of the heating unit 22 so that each of the springs 24 may be fixed to each of the plurality of fastening holes.

The cooktop 20 may be provided with a plurality of heating units 22. When the plurality of heating units 22 are provided as described above, a plurality of heating unit receiving holes 212 may be formed to extend through the base plate 21 in a corresponding manner to the plurality of heating units 22.

The top plate 23 may be mounted onto the base plate 21.

The top plate 23 defines the upper surface of the cooktop 20, and an open upper surface of the heating unit 22 may be shielded with the top plate 23 in a state in which the top plate is mounted onto the base plate 21.

In order to mount the top plate 23, a top plate receiving space 211 may be formed so as to be recessed downwards into the base plate 21. The top plate receiving space 211 may be recessed to have a size corresponding to that of the top plate 23.

In addition, a recessed depth of the top plate receiving space 211 may correspond to a thickness of the top plate 23. In this regard, as illustrated, the plurality of heating unit receiving holes 212 may be located in an inner area of the top plate receiving space 211.

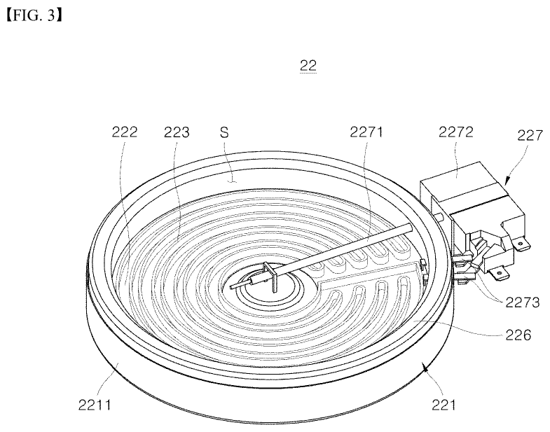

In FIGS. 3 to 5, a detailed configuration of the individual heating units 22 constituting the cooktop 20 is illustrated.

As described above, the heating unit 22 may be elastically fixed and mounted to the base plate 21 via the spring 24 in such a way that the heating unit passes through the heating unit receiving hole 212 and is partially inserted into the heating unit receiving hole 212.

The heating unit 22 functions to directly or indirectly heat the container placed on the upper surface of the top plate 23, and may be variously configured according to the type of the heat source. Accordingly, the heating unit 22 may be referred to as a heater or a burner.

The heating unit 22 may be embodied as one of a closed type heater, a radiant type heater, or an induction type heater according to a heat source.

FIGS. 3 to 5 illustrate an example of a configuration of the heating unit 22 embodied as the radiant type heater that generates heat. Hereinafter, the present disclosure will be described based on the configuration as shown in which the heating unit 22 is embodied as the radiant type heater.

The heating unit 22 may include a heating coil 223 that generates heat when power is supplied thereto, a thermal insulator 222 and 226 on which the heating coil 223 is seated, and the casing 221 coupled to an outer side surface of the thermal insulator 222 and 226 to protect the thermal insulator 222 and 226 and the heating coil 223.

The heating coil 223 performs a function of generating high-temperature heat on receiving the electrical power from the power supply.

In this regard, heat generated from the heating coil 223 may pass through the top plate 23 and be transferred to the container in a radiation or conduction manner to heat the container.

The heating coil 223 may be configured to generate heat in an electric resistance manner, and may be wound a plurality of times to have circular shapes having different inner diameters.

More specifically, as illustrated in FIGS. 3 to 5, the heating coil 223 is not formed in a perfect circular shape, but may have a general circular shape.

The heating coil 223 may be repeatedly bent in order to maximize the surface area to increase the heating amount to the maximum level.

In one example, the heating coil 223 may be repeatedly bent in a zigzag shape in a top view, and may extend to have a general circular ring shape.

In addition, in order to maximize the amount of the heat generated therefrom, the heating coil 223 may be constructed such that circular ring shapes having different diameters and having concentricity are arranged in a radial manner.

In one example, the heating coil 223 may be divided into an inner coil 224 and an outer coil 225. Accordingly, the amount of heat for heating the container may be adjusted according to a combination of the on/off operations of the inner coil 224 and the outer coil 225.

The heating coil 223 may be supported on and fixed by the thermal insulation pad 222 in a state of being seated on an upper surface of the thermal insulation pad 222 constituting the thermal insulator 222 and 223.

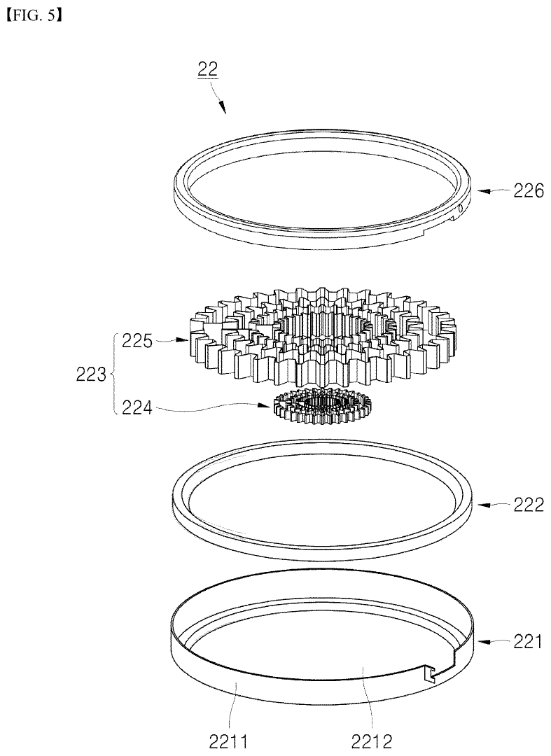

In more detail, the thermal insulator 222 and 226 may include the thermal insulation pad 222 formed in a disk shape as shown in FIG. 5.

The thermal insulation pad 222 may be disposed inside the casing 221 in a state of being entirely accommodated inside the casing 221 to be described later.

When the power is supplied to the heating coil 223, the surface temperature of the heating coil 223 may be increased to a maximum of about 2000 °C.

The thermal insulation pad 222 may be made of a non-flammable thermal insulation material to be suitable for a high-temperature environment formed by the heating coil 223.

As described above, as the heating coil 223 is seated on the upper surface of the thermal insulation pad 222 made of the non-flammable thermal insulation material, the thermal insulation pad 222 may minimize the transfer of heat in the downward direction when the heating coil 223 is heated. In addition, the heating coil 223 may be disposed on the upper surface of the thermal insulation pad 222.

In one example, the thermal insulator 222 and 226 may further include the thermal insulation ring 226 formed in a circular ring shape as shown in FIG. 5.

Like the thermal insulation pad 222, the thermal insulation ring 226 may be made of the non-flammable thermal insulation material to be suitable for a high-temperature environment formed by the heating coil 223.

In this regard, the thermal insulation ring 226 may extend along an outer edge of the thermal insulation pad 222 and may be disposed to be coupled to the outer edge of the thermal insulation pad 222.

Accordingly, as the thermal insulation ring 226 is coupled to the thermal insulation pad 222, an accommodation space S in which the heating coil 223 may be entirely accommodated may be formed radially inwardly of the thermal insulation ring 226 and on top of the thermal insulation pad 222.

In one example, an upper end of the thermal insulation ring 226 may be disposed to be in surface contact with a lower surface of the top plate 23.

In this regard, the upper end of the thermal insulation ring 226 may be maintained in a state of elastically contacting the lower surface of the top plate 23 under the pressing force of the spring 24 as described above.

Accordingly, the thermal insulation ring 226 and the top plate 23 may be effectively hermetically sealed to each other using the spring 24, and thus an amount of the heat inside the heating unit 22 discharged in a convection manner to the outside out of the heating unit 22 may be minimized.

In one example, the casing 221 is coupled to the outer surface of the thermal insulator 222 and 226 to protect the thermal insulator 222 and 226 and the heating coil 223.

The casing 221 may be formed in a cylindrical shape with an open upper surface so as to accommodate the thermal insulation pad 222 and the thermal insulation ring 226 therein and protect them.

Thus, the casing 221 may be formed by pressing a plate made of a predetermined metal material so as to be suitable for a high-temperature environment and such that the thermal insulation pad 222 and the thermal insulation ring 226 having relatively low rigidity are effectively protected by the casing 221.

Since the casing 221 is generally formed in a cylindrical shape, the casing 221 may include a disk-shaped bottom surface portion 2212 and a cylindrical side surface portion 2211 extending along the outer edge of the bottom surface portion 2212 and protruding upwards therefrom.

The cylindrical side surface portion 2211 of the casing 221 may be formed in a cylindrical shape corresponding to the shape of each of the outer circumferential surface of the thermal insulation pad 222 and the outer circumferential surface of the thermal insulation ring 226.

In this regard, the outer circumferential surface of the thermal insulation pad 222 may be entirely covered with the cylindrical side surface portion 2211, while the outer circumferential surface of the thermal insulation ring 226 may be partially covered with the cylindrical side surface portion 2211.

That is, as described above, an upper end of the cylindrical side surface portion 2211 may be positioned at a lower position in the up-down direction than that of an upper surface of the thermal insulation ring 226 so that the thermal insulation ring 226 may be formed in a surface contact state on the lower surface of the top plate 23.

Accordingly, the thermal insulation ring 226 may be exposed to the outside in an area between the upper end surface of the thermal insulation ring 226 and the upper end of the cylindrical side surface portion 2211 in the up-down direction.

The bottom surface portion 2212 of the casing 221 may include a first bottom surface 2212a connected to a lower end edge of the cylindrical side surface portion 2211 and a second bottom surface 2212b disposed radially inwardly of the first bottom surface 2212a.

As illustrated, the second bottom surface 2212b may be formed concavely in the downward direction so as to be positioned at a lower position in the up-down direction than a position of the first bottom surface 2212a.

A horizontal width of the first bottom surface 2212a may correspond to a horizontal thickness of the above-described thermal insulation ring 226, and the area size of the second bottom surface 2212b may correspond to the area size occupied with the heating coil 223.

As described above, the second bottom surface 2212b having the area size corresponding to the area size occupied with the heating coil 223 is concavely formed in the downward direction, so that a vertical height of the accommodation space S in which the heating coil 223 is seated may be increased, and as will be described later, a spare space for receiving a thermostat 2271 therein may be secured.

In one example, a fastening hole 2212h for fastening the above-described spring 24 may be formed in the first bottom surface 2212a.

One end of the spring 24 may be fastened to the fastening hole 2212h of the first bottom surface 2212a using a fastening means (not shown) such as a screw bolt.

However, as described above, the number of the springs 24 may be set to vary based on the size or the weight of the heating unit 22.

In order to secure design diversity and tolerance in which the spring design may be set to vary according to the shape and weight of the heating unit 22, the plurality of fastening holes 2212h may be formed in the first bottom surface 2212a so as to be arranged in the circumferential direction, and a circumferential spacing between the fastening holes 2212h may be variously set.

In one example, the heating unit 22 may further include an overheating prevention device 227 disposed on the outer surface of the casing 221.

More specifically, as illustrated in FIGS. 3 to 5, the overheating prevention device 227 may include the thermostat 2271 extending from the outside out of the casing 221 into the inner accommodation space S of the thermal insulator 222 and 226, and a housing 2272 disposed on the outer surface of the casing 221.

As illustrated, the thermostat 2271 may be provided in a rod shape, and one end of the rod shape may be disposed inside the housing 2272 and the other end of the rod shape may be disposed at a center of the inner accommodation space S.

That is, while the thermostat 2271 is positioned on top of the heating coil 223, the thermostat 2271 may extend across the heating coil 223, and detect whether the accommodation space S in which the heating coil 223 is disposed is overheated.

Although not shown, a switch for controlling an electrical connection between a pair of terminals 2273 for supplying power to the heating coil 223 and the power supply is connected inside the housing 2272.

Accordingly, when overheating or overload occurs in the heating coil 223 or the accommodation space S and thus the temperature of the accommodation space S rises to a predetermined set temperature or higher, the switch disposed inside the housing 2272 is opened by the thermostat 2271, and thus the power supply to the heating coil 223 may be immediately cut off.

Since any means known in the art may be applied to the detailed configuration of the overheating prevention device 227, a detailed description of the detailed configuration thereof will be omitted.

In one example, although not shown, the heating unit 22 of the cooking appliance according to the present disclosure may further include a thermal efficiency improvement means 25 as a means for improving the heating efficiency and power efficiency of the heating coil 223.

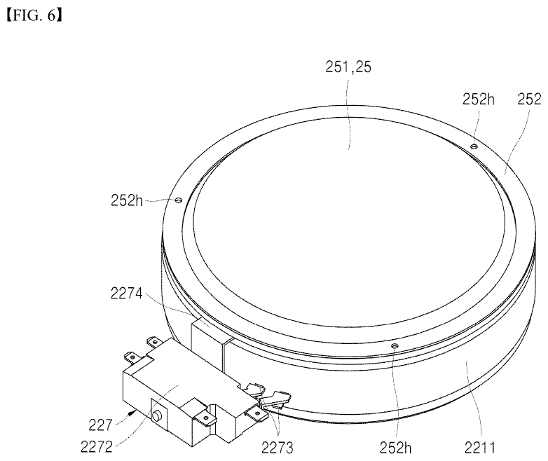

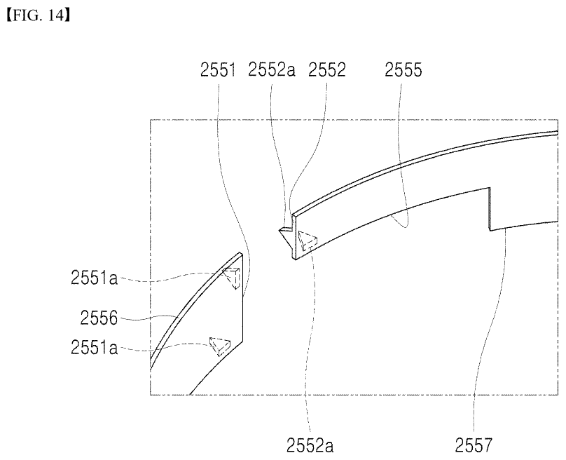

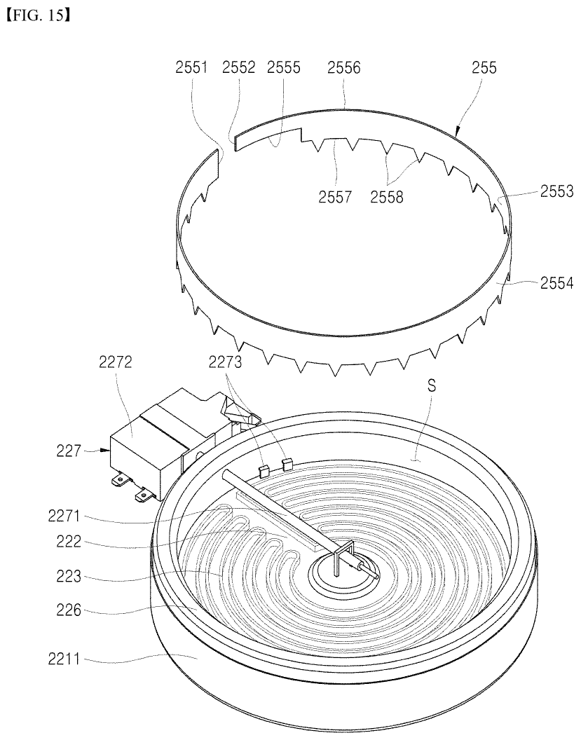

Hereinafter, a detailed configuration of the thermal efficiency improvement means 25 according to various embodiments will be described with reference to FIGS. 6 to 19.

### First Embodiment: Detailed Configuration of Heating Unit Including First Outer Thermal Insulator

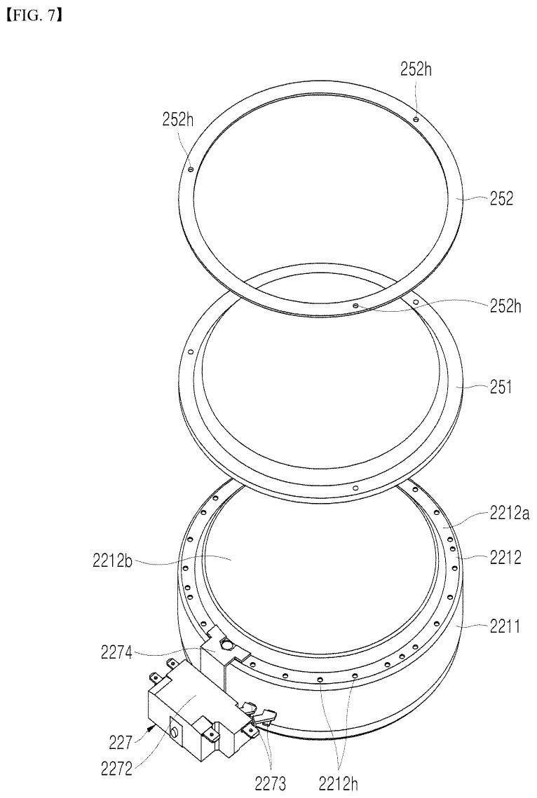

FIGS. 6 and 7 illustrate a configuration in which the thermal efficiency improvement means 25 according to the first embodiment of the present disclosure is provided.

As described above, a purpose of the present disclosure is to improve the heating efficiency of the heating coil 223 constituting the heating unit 22 using the thermal efficiency improvement means 25.

FIGS. 6 and 7 illustrate a first outer thermal insulator 251 disposed on an outer surface of the casing 221 as a first embodiment of the thermal efficiency improvement means 25.

The first outer thermal insulator 251 serves to minimize the discharge of the heat generated from the heating coil 223 through the bottom surface portion 2212 of the casing 221.

To this end, as illustrated, the first outer thermal insulator 251 may be coupled to an outer surface of the bottom surface portion 2212 of the casing 221 and may be disposed to cover the bottom surface portion 2212 of the casing 221 while being disposed on the outer surface of the casing 221.

In order to maximize the thermal insulating effect on the bottom surface portion 2212 of the casing 221 and the thermal retention effect on the casing 221, the first outer thermal insulator 251 may be disposed to entirely cover a first bottom surface 2212a and a second bottom surface 2212b constituting the bottom surface portion 2212 of the casing 221 while being disposed on the outer surface thereof.

Accordingly, in correspondence to the bottom surface portion 2212 of the casing 221 having a disk shape, the first outer thermal insulator 251 may be embodied as a circular pad having a predetermined thickness.

As illustrated, the first outer thermal insulator 251 is disposed on the outer surface of the bottom surface portion 2212 of the casing 221.

Accordingly, the first outer thermal insulator 251 is disposed in a lower temperature environment than that of a temperature environment in which the thermal insulation pad 222 and the thermal insulation ring 226 disposed in the inner space of the casing 221 and directly exposed to the heat generation from the heating coil 223 are disposed.

Accordingly, the first outer thermal insulator 251 may be made of a material having a heat resistance temperature lower than the heat resistance temperature of the thermal insulation pad 222 and the thermal insulation ring 226.

However, in order to prepare for the risk of fire due to overheating of the heating coil 223, the first outer thermal insulator 251 may be made of a non-flammable thermal insulating material as each of the insulating pad 222 and the insulating ring 226 may be.

In one example, as described above, the first outer thermal insulator 251 is attached to the outer surface of the bottom surface portion 2212 of the casing 221.

The first outer thermal insulator 251 may be constructed to be directly fixed to the bottom surface portion 2212 of the casing 221 via an adhesive or the like. However, the adhesive is highly likely to be affected by heat generation from the heating coil 223.

Accordingly, the means for fixing the first outer thermal insulator 251 to the bottom surface portion 2212 of the casing 221 may include a first holder 252 for fixing the first outer thermal insulator 251 to the bottom surface portion 2212 of the casing 221.

For example, FIGS. 6 and 7 illustrate a configuration in which the first holder 252 is formed in a single circular ring shape extending along an outer edge of the first outer thermal insulator 251.

However, this is only an example, and a configuration in which the first holder 252 is divided into a plurality of pieces naturally belongs to the scope of the present disclosure. Hereinafter, the present disclosure will be described on the basis of a configuration in which the first holder 252 is provided in the single circular ring shape. However, the present disclosure is not limited thereto.

In this regard, an outer diameter of the first holder 252 having the ring shape may have a dimension equal to or slightly smaller than a diameter of the bottom surface portion 2212 of the casing 221.

In addition, an inner diameter of the first holder 252 having the ring shape may have a dimension smaller than or equal to an inner diameter of the first bottom surface 2212a constituting the bottom surface portion 2212 of the casing 221.

Accordingly, a radial width of the first holder 252 may be equal to or slightly smaller than a radial width of the first bottom surface 2212a of the bottom surface portion 2212.

In addition, as illustrated in FIG. 6, a thickness of the first holder 252 may be maintained to be uniform while the first holder extends along the circumferential direction, and may be sized to be smaller than or equal to a vertical dimension by which the second bottom surface 2212b protrudes from the first bottom surface 2212a.

As described above, the radial width of the first holder 252 is sized to be smaller than or equal to the radial width of the first bottom surface 2212a and the thickness of the first holder 252 is sized to be smaller than or equal to the protruding height of the second bottom surface 2212b, thereby providing a uniform fixing force along the circumferential direction with respect to the first outer thermal insulator 251 while minimizing interference with other components constituting the cooktop 20.

In one example, the first holder 252 may have a first through-hole 252h extending therethrough toward the first bottom surface 2212a of the bottom surface portion 2212 of the casing 221.

In this regard, as illustrated, a plurality of fastening holes 2212h for fixing the spring 24 may be formed to extend through the first bottom surface 2212a of the bottom surface portion 2212 of the casing 221.

As described above, in order to secure design diversity and tolerance in which the spring design may be set to vary according to the shape and weight of the heating unit 22, the plurality of fastening holes 2212h may be formed in the first bottom surface 2212a so as to be arranged in the circumferential direction thereof. The number of fastening holes 2212h may be much larger than the number of springs 24.

In order to fix the first holder 252 according to the first embodiment of the present disclosure using the already formed fastening holes 2212h, the first through-holes 252h of the first holder 252 may be respectively formed at positions corresponding to some fastening holes 2212h among the plurality of fastening holes 2212h.

However, in order to prevent interference with the fixing and installation of the spring 24, some fastening holes 2212h may be selected as unused fastening holes 2212h to which the spring 24 is not fastened.

The first holder 252 may be fixed using a fastener, for example, a screw bolt, which may simultaneously pass through the first through-hole 252a, the first outer thermal insulator 251, and the unused fastening hole 2212h.

### Second Embodiment: Detailed Configuration of Heating Unit Including Second Outer Thermal Insulator

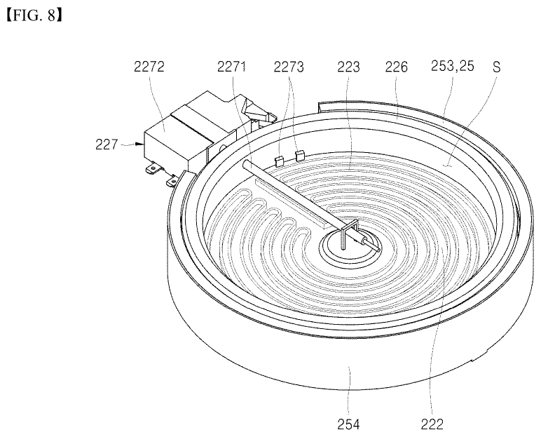

FIGS. 8 to 10 illustrate a configuration in which the thermal efficiency improvement means 25 according to the second embodiment of the present disclosure is provided.

FIGS. 8 to 10 illustrate a second outer thermal insulator 253 disposed on the outer surface of the casing 221 as a second embodiment constituting the thermal efficiency improvement means 25.

The second outer thermal insulator 253 serves to minimize the discharge of heat generated from the heating coil 223 through the cylindrical side surface portion 2211 of the casing 221.

To this end, as illustrated, the second outer thermal insulator 253 may be coupled to the outer side surface of the cylindrical side surface portion 2211 of the casing 221 and may be disposed to cover the cylindrical side surface portion 2211 of the casing 221 while being disposed on the outer side surface of the casing 221.

In order to maximize the thermal insulation effect and the thermal retention effect on the casing 221 and the thermal insulation ring 226 serving as the inner thermal insulator, the second outer thermal insulator 253 may be disposed to entirely cover the cylindrical side surface portion 2211 of the casing 221 and the thermal insulation ring 226 while being disposed on the outer surface thereof.

Accordingly, in correspondence to the cylindrical side surface portion 2211 of the casing 221 having the cylindrical shape and the thermal insulation ring 226 having the ring shape, the second outer thermal insulator 253 may be embodied as a cylindrical pad having a predetermined thickness.

However, in order to prevent interference with the above-described overheating prevention device 227, the second outer thermal insulator 253 may be formed to have a C-shaped cross section rather than a complete cylindrical shape so as to avoid a position where the housing 2272 and the terminal 2273 of the overheating prevention device 227 are formed.

In one example, as illustrated, the second outer thermal insulator 253 is disposed on the outer side surface of the cylindrical side surface portion 2211 of the casing 221 and the outer side surface of the thermal insulation ring 226.

Therefore, like the first outer thermal insulator 251, the second outer thermal insulator 253 is disposed in a lower temperature environment than a temperature of the temperature environment in which the thermal insulation pad 222 and the thermal insulation ring 226 are disposed. For this reason, the second outer thermal insulator 253 may be made of a material having a lower heat resistance temperature than the heat resistance temperature of the thermal insulation pad 222 and the thermal insulation ring 226.

However, in order to cope with the risk of fire due to overheating of the heating coil 223, the second outer thermal insulator 253 may be made of a non-flammable thermal insulation material as each of the thermal insulation pad 222 and the thermal insulation ring 226 may be. Preferably, the second outer thermal insulator 253 may be made of the same material as that of the first outer thermal insulator 251.

In one example, as described above, the second outer thermal insulator 253 is attached to the outer side surface of the cylindrical side surface portion 2211 of the casing 221.

The second outer thermal insulator 253 may be constructed to be directly fixed to the cylindrical side surface portion 2211 of the casing 221 using an adhesive or the like. However, as in the first outer thermal insulator 251, the adhesive is highly likely to be affected by heat generation from the heating coil 223.

Accordingly, a means for fixing the second outer thermal insulator 253 to the bottom surface portion 2212 of the casing 221 may include a second holder 254 for fixing the second outer thermal insulator 253 to the cylindrical side surface portion 2211 of the casing 221 may be included.

For example, FIGS. 8 to 10 illustrate a configuration in which the second holder 254 is formed in a single cylindrical shape extending along the outer circumferential surface of the second outer thermal insulator 253.

However, this is only an example, and a configuration in which the second holder 254 is divided into a plurality of pieces similarly to the first holder 252 naturally belongs to the scope of the present disclosure. The present disclosure is not limited thereto, but hereinafter, the present disclosure will be described on the basis of the configuration in which the second holder 254 is provided in the single circular ring shape.

In this regard, a vertical width of the second holder 254 having the cylindrical shape may be equal to or slightly smaller than a vertical width of the second outer thermal insulator 253.

As described above, the vertical width of the second holder 254 is sized to be smaller than or equal to the vertical width of the second outer thermal insulator 253, such that a portion of the second holder 254 protruding beyond the heating unit 22 in the up-down direction is absent, thereby providing an uniform fixing force to the second outer thermal insulator 253 along the circumferential direction while minimizing interference with other components constituting the cooktop 20.

In one example, the second holder 254 may include a connection tab 254a bent toward the first bottom surface 2212a of the bottom surface portion 2212 of the casing 221.

That is, one end of the connection tab 254a may be integrally formed with a lower end edge of the second holder 254, and the other end thereof may be a free end bent and extending toward the first bottom surface 2212a.

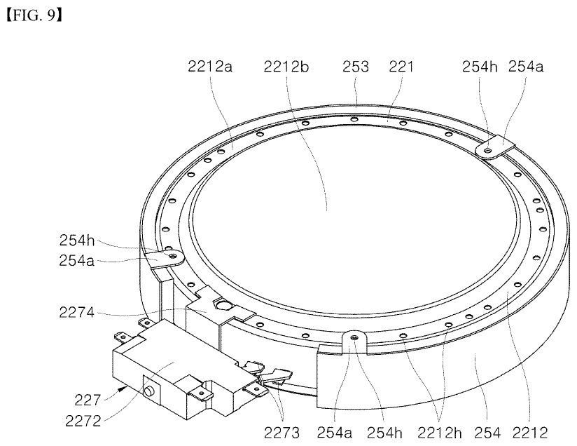

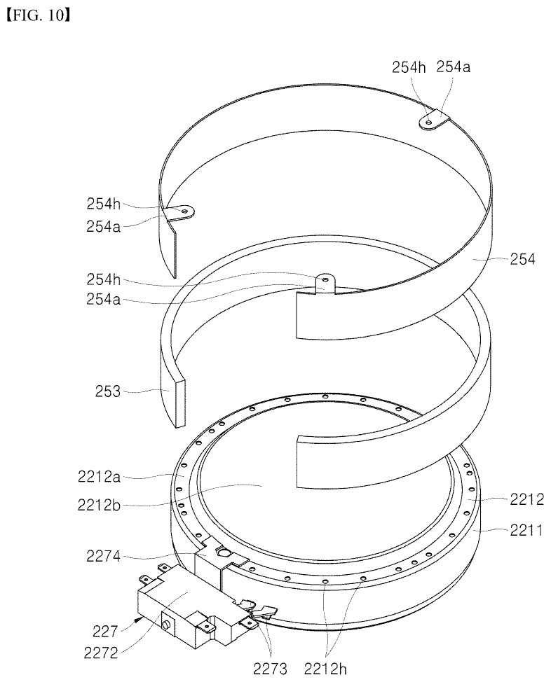

FIGS. 9 and 10 illustrate an embodiment in which a total of three connection tabs 254a are provided, but this is only an example, and the number of connection tabs 254a may be further increased or decreased according to the size of the heating unit 22.

Each of the connection tabs 254a may have a second through-hole 254h formed to extend therethrough toward the first bottom surface 2212a.

In this regard, as described above, the plurality of fastening holes 2212h for fixing the spring 24 may be formed to pass through the second bottom surface 2212b of the bottom surface portion 2212 of the casing 221. Similarly to the first holder 252, the second through-holes 254h of the connection tab 254a of the second holder 254 may be respectively formed at positions corresponding to those of some fastening holes 2212h among the plurality of fastening holes 2212h so that the second holder 254 may be fixed via the coupling between the fastening holes 2212h already formed and the second through-holes 254h using the screw bolts.

However, in order to prevent interference with the fixing and installation of the spring 24, some of the fastening holes 2212h to which the spring 24 is not fastened may be selected as the unused fastening holes 2212h to which the connection tab 254a is fixed.

The connection tab 254a of the second holder 254 may be fixed to the casing using a fastener, for example, the screw bolt, which may simultaneously pass through the second through-hole 254h, the second outer thermal insulator 253, and the unused fastening hole 2212h.

### Third Embodiment: Detailed Configuration of Heating Unit Including First Outer Thermal Insulator and Second Outer Thermal Insulator

Although it has been described above that the heating unit 22 includes only one of the first outer thermal insulator 251 according to the first embodiment and the second outer thermal insulator 253 according to the second embodiment, the heating unit 22 may be configured to include both the first outer thermal insulator 251 according to the first embodiment and the second outer thermal insulator 253 according to the second embodiment.

When, as described above, the heating unit 22 is configured to include both the first outer thermal insulator 251 according to the first embodiment and the second outer thermal insulator 253 according to the second embodiment, the thermal insulation effect and the thermal retention effect on the heating unit 22 may be further improved compared to the case in which only one of the first outer thermal insulator 251 and the second outer thermal insulator 253 is provided.

In this regard, the first outer thermal insulator 251 and the second outer thermal insulator 253 may be integrally formed with each other and be attached to the outer surface of the casing 221.

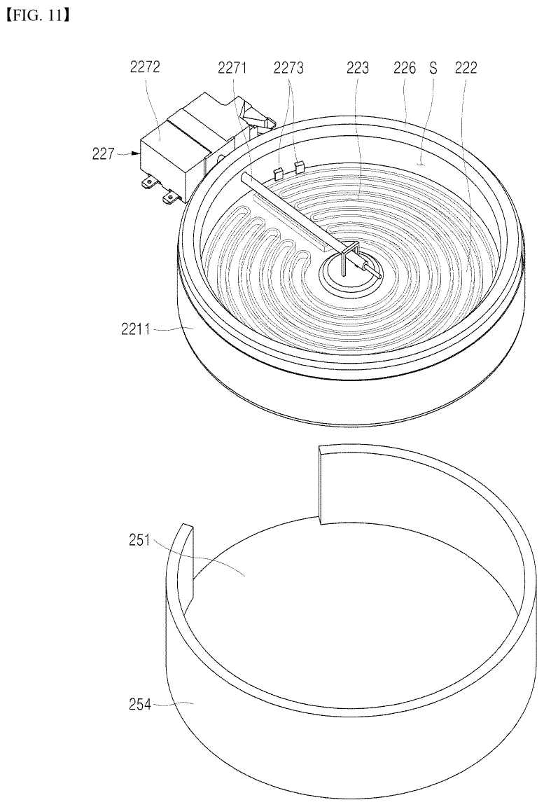

FIG. 11 illustrates a configuration in which the first outer thermal insulator 251 and the second outer thermal insulator 253 are integrated with each other and disposed on the outer surface of the casing 221 as a third embodiment constituting the thermal efficiency improvement means 25.

As the first outer thermal insulator 251 and the second outer thermal insulator 253 are integrated with each other in this way, the heat may be prevented from being dissipated through a gap defined between the first outer thermal insulator 251 and the second outer thermal insulator 253 when the first outer thermal insulator 251 and the second outer thermal insulator 253 are separate from each other, thereby further improving the thermal insulation effect and the thermal retention effect.

In addition, when the first outer thermal insulator 251 and the second outer thermal insulator 253 are separate from each other, the first holder 252 and the second holder 254 should be provided, respectively. However, when the first outer thermal insulator 251 and the second outer thermal insulator 253 are integrated with each other, the single integrated body of the first outer thermal insulator 251 and the second outer thermal insulator 253 may be fixed to the casing 221 using a single holder, and thus an effect of simplifying the configuration may be expected.

In this regard, although not shown in FIG. 11, the second holder 254 shown in FIGS. 9 and 11 may be more suitable as a means for fixing the integrated body of the first and second outer thermal insulators 251 and 253 to the casing 221.

This is because when the first outer thermal insulator 251 and the second outer thermal insulator 253 integrated with each other are attached to the casing 221 only using the first holder 252, there may be a possibility that the second outer thermal insulator 253 may not be effectively supported and fixed.

### Fourth Embodiment: Detailed Configuration of Heating Unit Having Reflector

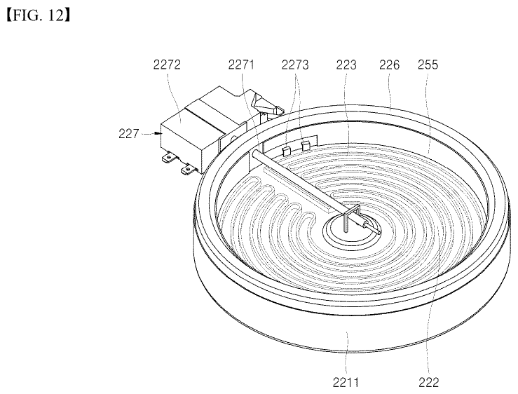

FIGS. 12 to 19 illustrate a configuration in which the thermal efficiency improvement means 25 according to a fourth embodiment of the present disclosure is provided.

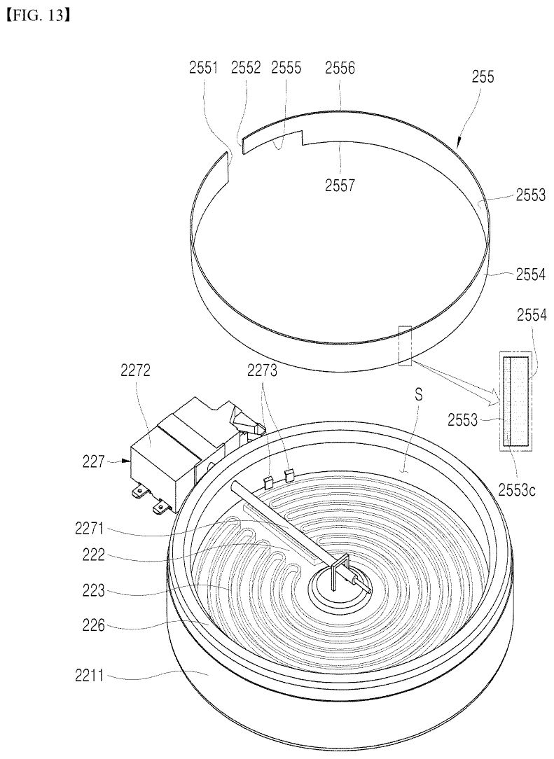

First, referring to FIGS. 12 and 13, as a fourth embodiment of the thermal efficiency improvement means 25, a reflector 255 disposed inside the accommodation space S defined by the thermal insulation pad 222 and the thermal insulation ring 226 is illustrated.

A substantial portion of the heat generated from the heating coil 223 disposed in the accommodation space S defined by the thermal insulation pad 222 and the thermal insulation ring 226 is transferred to the lower surface of the top plate 23 in a form of the radiant heat, and the radiant heat transferred to the top plate 23 is used to heat the container.

As described above, a portion of the radiant heat generated from the heating coil 223 is transferred toward the inner circumferential surface defining the accommodation space S, and the reflector 255 according to the fourth embodiment of the present disclosure reflects the radiant heat transferred toward the inner circumferential surface defining the accommodation space S therefrom such that the reflected heat is directed toward the lower surface of the top plate 23, thereby improving the thermal efficiency of the heating coil 223.

In order to maximize the reflection efficiency with respect to the radiant heat, the reflector 255 may be disposed to cover an entirety of the inner circumferential surface defining the accommodation space S.

Accordingly, the reflector 255 may be formed in a cylindrical shape having a predetermined thickness and in a corresponding manner to the inner circumferential surface defining the accommodation space S having the cylindrical shape.

In order to prevent interference with the above-described overheating prevention device 227, the second outer thermal insulator 253 may be formed to have a C-shaped cross section rather than a complete cylindrical shape so as to avoid a position where the thermostat 2271 of the overheating prevention device 227 is formed.

However, although FIG. 13 and subsequent drawings thereto discloses a configuration in which the reflector 255 is formed in a continuous ring shape having the general C-shape, this is only an example. In another example, the reflector 255 may be formed in a partially cut ring shape or a polygonal shaped inner plate form in which a plurality of plate members are continuously or discontinuously arranged. Hereinafter, the present disclosure will be described based on a configuration in which the reflector 255 is formed in the continuous ring shape having the general C-shape. However, the present disclosure is not limited thereto.

In addition, a predetermined notch 2555 may be formed in a front edge 2551 or a rear edge 2552 of the reflector 255 so as to avoid the pair of terminals 2273 extending into the accommodation space S.

In order to entirely cover the inner circumferential surface defining the accommodation space S, the reflector 255 may be disposed between the inner circumferential surface defining the accommodation space S and the heating coil 223 in the horizontal direction, a lower end edge 2557 of the reflector 255 may contact a lower end surface defining the accommodation space S, that is, an upper end surface of the thermal insulation pad 222, and an upper end edge 2556 of the reflector 255 may contact an upper end surface defining the accommodation space S, that is, an upper end surface of the thermal insulation ring 226.

In one example, the reflector 255 is disposed at a position at which the reflector is directly exposed to a high temperature environment generated by the heating coil 223, and is heated by the radiant heat from the heating coil 223.

Therefore, the reflector 255 may be made of a metal material having much higher heat resistance than that of each of the casing 221, the first holder 252, and the second holder 254 described above. Preferably, the reflector 255 may be formed by pressing a plate made of a stainless steel material.

However, the possibility that the reflector may be damaged by the conductive heat from the heating coil 223 is high, and the possibility that a short circuit between the reflector and the heating coil may occur when the reflector contacts the heating coil 223 through which the electric current flows is high. For this reason, the reflector 255 should be maintained in a state of being spaced from the heating coil 223 and may be disposed in a state of being in close contact with the inner circumferential surface defining the accommodation space S.

To this end, the reflector 255 may be formed to have a smaller thickness than a spacing in the lateral direction between the inner circumferential surface defining the accommodation space S and the outermost heating coil 223.

In one example, as described above, the reflector 255 serves to reflect the radiant heat generated from the heating coil 223 therefrom such that the reflected heat is directed toward the top plate 23.

In order to increase the reflection efficiency of the top plate 23, an inner circumferential surface 2553 of the reflector 255 facing toward the heating coil 223 may be provided to have a higher reflectance than that of an outer circumferential surface 2554 thereof facing toward the inner circumferential surface defining the accommodation space S.

In order to allow the inner circumferential surface 2553 of the reflector 255 to have the higher reflectance than that of the outer circumferential surface 2554 thereof, the inner circumferential surface 2553 of the reflector 255 may be surface-treated to have a lower surface roughness than that of the outer circumferential surface 2554, or as illustrated in FIG. 13, a coating layer 2553c made of a material having a higher reflectance may be formed on the inner circumferential surface 2553 of the reflector 255.

In this regard, the coating layer 2553c may be made of a material having heat resistance to the extent that the coating layer is not damaged or affected by the radiant heat from the heating coil 223.

As described above, the reflector 255 may be disposed in the accommodation space S such that the outer circumferential surface 2554 thereof is in close contact with the inner circumferential surface defining the accommodation space S.

As, as described above, the reflector 255 is disposed in close contact with the inner circumferential surface defining the accommodation space S, the rigidity of the inner area of the heating unit 22 may be additionally reinforced.

As illustrated in FIG. 13, the reflector 255 may be formed to have an outer diameter greater than an inner diameter of the inner circumferential surface defining the accommodation space S.

Accordingly, as the reflector 255 is inserted into the accommodation space S, the outer diameter of the reflector 255 may be reduced to the same value as the inner diameter of the accommodation space S.

Accordingly, when the reflector 255 is seated in the accommodation space S, the state of close contact of the reflector 255 with respect to the inner circumferential surface defining the accommodation space S is maintained under a self-restoring force by which the reflector 255 returns to its original shape, and thus at least the horizontal movement of the reflector 255 may be prevented.

However, under the self-restoring force of the reflector 255, the upward and downward movement of the reflector 255 is not completely prevented. That is, the reflector 255 may be incompletely fixed.

A fixing means as a means for securing a state in which the reflector 255 is firmly fixed to the inner circumferential surface defining the accommodation space S may be added to the reflector 255.

The fixing means of the reflector 255 may include a front end fixing portion 2551a, a rear end fixing portion 2552a, and a lower end fixing portion 2559.

FIG. 13 illustrates the front end fixing portion 2551a and the lower end fixing portion 2559 serving as the fixing means of the reflector 255.

As illustrated, a wedge-shaped front end fixing portion 2551a may be formed onto each of a front end edge 2551 serving as one end of the reflector 255 and the lower end edge 2557 at a position adjacent to the front end edge 2551. A wedge-shaped rear end fixing portion 2552a may be formed onto each of a rear end edge 2552 serving as the other end thereof, and the lower end edge 2557 at a position adjacent to the rear end edge 2552. The wedge-shaped front end fixing portion 2551a and the wedge-shaped rear end fixing portion 2552a may be bent toward the inner circumferential surface defining the accommodation space S, and may be integrally formed with the reflector 255.

The thermal insulation ring 226 and the thermal insulation pad 222 constituting the inner thermal insulator of the heating unit 22 of the present disclosure may be made of a soft material having a strength similar to that of a gypsum material, which has much lower strength than that of the reflector 255.

Accordingly, the wedge-shaped front end fixing portion 2551a and the wedge-shaped rear end fixing portion 2552a may pierce the surface of each of the thermal insulation ring 226 and the thermal insulation pad 222 even when a relatively weak pressing force is applied thereto, and may be easily embedded and stuck in the thermal insulation ring 226 and the thermal insulation pad 222, and thus the free end thereof may be effectively and easily fixed to the thermal insulation ring 226 or the thermal insulation pad 222 at the front end edge 251 and the rear end edge 2552 of the reflector 255.

In one example, the lower end fixing portion 2559 of the reflector 255 may be formed in the wedge shape similar to that of each of the front end fixing portion 2551a and the rear end fixing portion 2552a.

However, unlike the front end fixing portion 2551a and the rear end fixing portion 2552a, the lower end fixing portions may be arranged along the lower edge 2557 of the reflector 255 and may extend downwards so as to pierce the upper surface of the thermal insulation pad 222 and be embedded and stuck into the thermal insulation pad 222.

In this regard, spacings between the lower end fixing portions 2559 may be approximately equal to each other so as to provide a fixing force uniform in the circumferential direction with respect to the lower edge 2557 of the reflector 255.

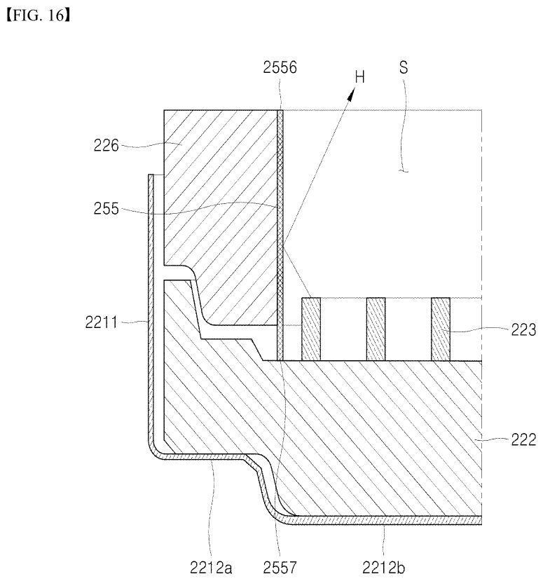

FIG. 16 illustrates a cross-sectional view of the reflector 255 cut along the vertical plane in a state in which the reflector 255 is disposed in the accommodation space S.

As illustrated in FIG. 16, the inner circumferential surface of the reflector 255 may be formed as a vertical surface extending at a right angle parallel to the inner circumferential surface of the thermal insulation ring 226 so that the reflector 255 may effectively cover the inner circumferential surface of the thermal insulation ring 226 defining the accommodation space S.

In this regard, as illustrated, at least the upper edge 2556 of the reflector 255 is located at the same vertical position as that of the upper end surface of the thermal insulation ring 226 in the up-down direction, and thus may be located at a higher vertical position in the up-down direction than that of the heating coil 223 seated on the upper surface of the thermal insulation pad 222.

Therefore, the radiant heat H generated from the heating coil 223 disposed adjacent to the reflector 255 and radiated toward the inner circumferential surface of the insulating ring 226 may be reflected from the inner circumferential surface 2553 of the reflector 255, so that the flow direction of the heat may be effectively changed toward the lower surface of the top plate 23.

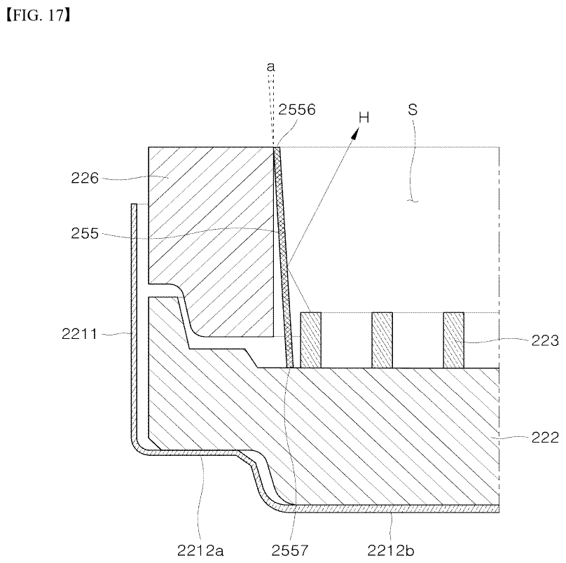

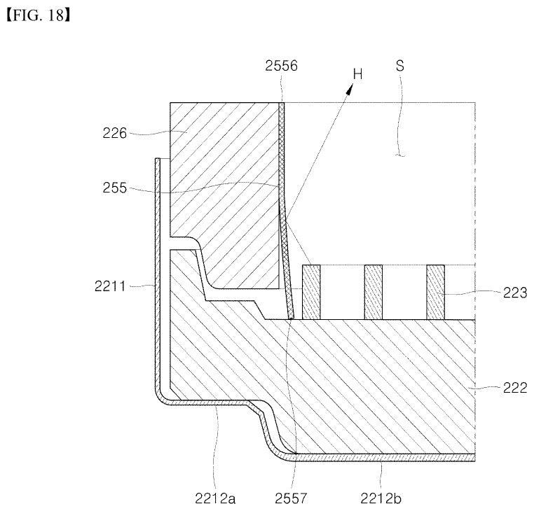

In this regard, as shown in FIGS. 17 and 18, in the cross-section shape of the reflector 255, the reflector may extend in an inclined manner or a curved manner in the up-down direction rather than in the vertical manner extending at a right angle as shown in FIG. 16.

The cross section shape of the reflector 255 may be formed in this manner, such that the inner circumferential surface 2553 of the reflector 255 facing toward the heating coil 223 may be formed as an inclined surface or a curved surface.

As, as illustrated, the inner circumferential surface 2553 of the reflector 255 is formed as the inclined surface or the curved surface, the flow path of the radiant heat H to the lower surface of the top plate 23 may be further shortened compared to the case in which the inner circumferential surface 2553 is formed as a vertical surface at a right angle, and thus the heating efficiency of the heating coil 223 may be further improved.

In one example, when, as illustrated in FIG. 17, the inner circumferential surface 2553 of the reflector 255 is formed as the inclined surface, an inclination angle “a” of the reflector 255 may be set in consideration of the thickness of the reflector 255 and the horizontal spacing between the inner circumferential surface of the thermal insulation ring 226 and the outermost heating coil 223. The inclination angle “a” may be set to have an angle range of approximately 3 to 5 degrees.

In addition, when, as illustrated in FIG. 18, the inner circumferential surface 2553 of the reflector 255 is formed as the curved surface, for the same reason, a radius of curvature of the inner circumferential surface 2553 of the reflector 255 may be set so as to gradually increase while the reflector 255 extends from the lower edge 2557 toward the upper edge 2556.

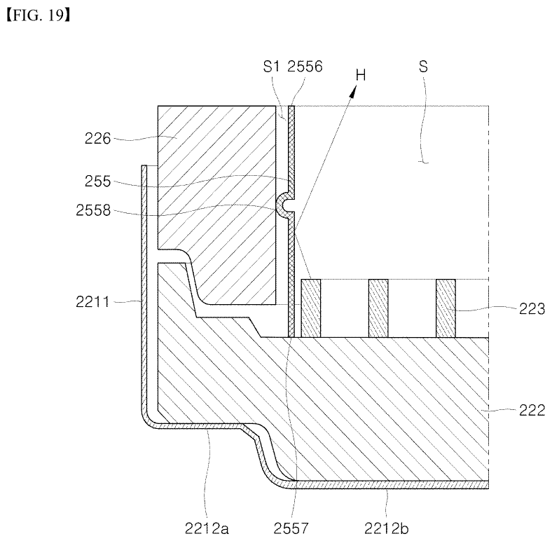

FIG. 19 illustrates a configuration in which each of the inner circumferential surface 2553 and the outer circumferential surface 2554 of the reflector 255 is formed as the vertical surface at the right angle in a similar manner to FIG. 17, and a protrusion 2558 is added to the outer circumferential surface 2554 of the reflector 255.

As the protrusion 2558 is added to the outer circumferential surface 2554 of the reflector 255, a predetermined separation space SI may be formed between the inner circumferential surface of the thermal insulation ring 226 as the inner circumferential surface defining the accommodation space S and the outer circumferential surface 2554 of the reflector 255.

Since the predetermined separation space S1 acts as an air layer, a thermal insulating layer capable of increasing the heating efficiency of the heating coil 223 is added to be disposed between the inner circumferential surface of the insulating ring 226 and the outer circumferential surface 2554 of the reflector 255.

A plurality of protrusions 2558 may be provided so that a size of the separation space S1 may be uniform along the circumferential direction, and the circumferential spacings between the protrusions 2558 may be approximately equal to each other.

As described above, in order to prevent contact between the inner circumferential surface of the reflector 255 and the heating coil 223, a sum of a dimension in the horizontal direction by which the protrusion 2558 protrudes from the outer circumferential surface 2554 of the reflector 255 and a thickness of the reflector 255 may be sized to be smaller than the horizontal spacing between the inner circumferential surface of the thermal insulation ring 226 and the outermost heating coil 223.

In one example, the protrusion 2558 added to the outer circumferential surface of the reflector 255 may be integrally formed with the reflector 255 via press-forming while being formed in an embossed shape, a bead-forming shape, a cut protrusion, or the like.

Although the present disclosure has been described above with reference to the drawings as illustrated in the present disclosure, the present disclosure is not limited by the embodiments and drawings disclosed in the present disclosure, and it is obvious that various modifications may be made by a person skilled in the art within the scope of the technical idea of the present disclosure. In addition, even though an effect of a configuration of the present disclosure is not explicitly described in describing the embodiment of the present disclosure above, it is obvious that the predictable effect from the configuration should be recognized.

1. A cooking appliance comprising:
a heating unit; and
a top plate disposed on top of the heating unit to shield the heating unit, wherein a container for cooking is seated on the top plate;
wherein the heating unit includes:
a heating coil generating heat in an electric resistance manner;
a thermal insulator accommodating the heating coil in an inner space defined therein;
a casing coupled to an outer surface of the thermal insulator; and
a thermal efficiency improvement means disposed in the inner space of the thermal insulator or disposed on an outer surface of the casing so as to improve heating efficiency of the heating coil.

2. The cooking appliance of claim 1, wherein the thermal efficiency improvement means includes:
a first outer thermal insulator coupled to an outer surface of a bottom surface portion of the casing and covering the bottom surface portion of the casing.

3. The cooking appliance of claim 2, wherein the heating unit includes:
a first holder for fixing the first outer thermal insulator to the bottom surface portion of the casing.

4. The cooking appliance of claim 3, wherein the first holder has first through-holes formed to pass therethrough toward the bottom surface portion of the casing,
wherein the bottom surface portion of the casing has fastening holes formed to pass therethrough and respectively positioned at positions corresponding to positions of the first through-holes.

5. The cooking appliance of claim 2, wherein the first outer thermal insulator has a lower heat resistance temperature than a heat resistance temperature of the thermal insulator.

6. The cooking appliance of claim 1, wherein the thermal efficiency improvement means includes:
a second outer thermal insulator coupled to an outer side surface of a cylindrical side surface portion of the casing to cover the cylindrical side surface portion of the casing.

7. The cooking appliance of claim 6, wherein the heating unit includes:
a second holder for fixing the second outer thermal insulator to the cylindrical side surface portion of the casing.

8. The cooking appliance of claim 7, wherein the second holder includes a connection tab bent from the second holder toward a bottom surface portion of the casing,
wherein the connection tab has second through-holes formed to pass therethrough toward the bottom surface portion of the casing,
wherein the bottom surface portion of the casing has fastening holes formed to pass therethrough in an up-down direction and respectively positioned at positions corresponding to positions of the second through-holes.

9. The cooking appliance of claim 6, wherein the second outer thermal insulator has a lower heat resistance temperature than a heat resistance temperature of the thermal insulator.

10. The cooking appliance of claim 1, wherein the thermal efficiency improvement means includes:
a first outer thermal insulator coupled to an outer surface of a bottom surface portion of the casing and covering the bottom surface portion of the casing; and
a second outer thermal insulator coupled to an outer side surface of a cylindrical side surface portion of the casing to cover the cylindrical side surface portion of the casing,
wherein the first outer thermal insulator and the second outer thermal insulator are integrally formed with each other.

11. The cooking appliance of claim 1, wherein the thermal efficiency improvement means includes:
a reflector disposed in the inner space defined in the thermal insulator, and disposed between an inner circumferential surface of the thermal insulator and the heating coil, wherein the reflector reflects heat generated from the heating coil therefrom such that the reflected heat is directed toward the top plate.

12. The cooking appliance of claim 11, wherein the reflector has an inner circumferential surface facing toward the heating coil and an outer circumferential surface facing toward the inner circumferential surface of the thermal insulator, wherein the inner circumferential surface of the reflector has a higher reflectance than a reflectance of the outer circumferential surface of the reflector.

13. The cooking appliance of claim 12, wherein the inner circumferential surface of the reflector is surface-treated to have a higher reflectance than a reflectance of the outer circumferential surface of the reflector.

14. The cooking appliance of claim 12, wherein the inner circumferential surface of the reflector is coated with a material having a higher reflectance than a reflectance of the outer circumferential surface of the reflector.

15. The cooking appliance of claim 11, wherein the reflector has an inner circumferential surface facing toward the heating coil and an outer circumferential surface facing toward the inner circumferential surface of the thermal insulator, wherein the outer circumferential surface of the reflector is disposed to be in contact with the inner circumferential surface of the thermal insulator.

16. The cooking appliance of claim 15, wherein the inner circumferential surface of the reflector is a vertical surface extending at a right angle and in parallel with the inner circumferential surface of the thermal insulator.

17. The cooking appliance of claim 15, wherein the inner circumferential surface of the reflector is an inclined surface tilted toward the top plate.

18. The cooking appliance of claim 15, wherein the inner circumferential surface of the reflector is a curved surface concave toward the top plate.

19. The cooking appliance of claim 11, wherein the reflector has an inner circumferential surface facing toward the heating coil and an outer circumferential surface facing toward the inner circumferential surface of the thermal insulator, wherein a separation space is defined between the outer circumferential surface of the reflector and the inner circumferential surface of the thermal insulator.

20. The cooking appliance of claim 19, wherein the reflector has a protrusion formed to protrude from the outer circumferential surface of the reflector toward the inner circumferential surface of the thermal insulator.
